(19) United States
(12) Patent Application Publication
(10) Pub. No.: US 2021/0334920 A1
(43) Pub. Date: Oct. 28, 2021

(54) System for Interest-Aligned Educational Degree Planning

(71) Applicant: WISYS TECHNOLOGY FOUNDATION, INC., Madison, WI (US)

(72) Inventors: Athula Gunawardena, Whitewater, WI (US); Robert Meyer, Madison, WI (US)

(21) Appl. No.: 16/479,683

(22) PCT Filed: Jan. 22, 2018
(86) PCT No.: PCT/US2018/014716

§ 371 Date: Jul. 22, 2019

Related U.S. Application Data
(60) Provisional application No. 62/449,330, filed on Jan. 23, 2017.

(51) Int. Cl. G06Q 50/20; G06Q 30/02; G06Q 10/10; G06F 16/9535; G06F 16/9538

(52) U.S. Cl. CPC G06Q 50/2053; G06Q 30/0203; G06F 16/9538; G06F 16/9535; G06Q 10/10

(57) ABSTRACT

A system that characterizes majors and academic courses with vectors that can be matched to testable student interests is provided. Majors and courses can then be recommended by a matching of student interests with characterized courses. The system combines elements of both psychology and technology, to greatly reduce the challenge of selecting courses and majors, by automating parts of the complex selection process to produce understandable options. Improved matching of majors and courses to individuals can provide multiple benefits including improved educational outcomes, enhanced student retention, and significant reduction in student debt.

### CROSS REFERENCE TO RELATED APPLICATION

This application claims priority to U.S. provisional application No. 62/449,330, filed Jan. 23, 2017, and hereby incorporated by reference.

### BACKGROUND OF THE INVENTION

The present invention relates to an interactive, computerized system for developing degree plans and in particular to a system that can both provide an exhaustive matching of degree options to a student's quantified interests while managing the complexity of such a matching to assist in decision-making.

A typical, midsize university may have over 2000 individual courses spread through various majors. A student preparing a degree plan, that is, a list of courses they must take in order to successfully graduate, must locate courses of interest from this large number of options, while ensuring that the courses satisfy the requirement of a major and possibly minor field of study, can be scheduled in a desired number of semesters given course rotations, and meet other requirements of the institution, for example, distributional and prerequisite requirements.

As a practical matter, this process is manageable only after the student has identified an academic major, yet studies have indicated that 20 to 50 percent of students enter college as “undecided”. Selecting a major is particularly difficult for first generation students who lack the benefit of parental college experience to guide them through the options.

Encouraging a premature or ill-advised major selection is no less of a problem. Currently an estimated 75 percent change their major at least once before graduation. Such change usually leads to increased student debt, which, for the nation as a whole, is a well-publicized trillion-dollar societal issue.

### SUMMARY OF THE INVENTION

The present invention provides a system that characterizes majors and academic courses with vectors that can be matched to testable student interests. Majors and courses can then be recommended by a matching of student interests with characterized courses. The system combines elements of both psychology and technology, to greatly reduce the challenge of selecting courses and majors, by automating parts of the complex selection process to produce understandable options. Improved matching of majors and courses to individuals can provide multiple benefits including improved educational outcomes, enhanced student retention, and significant reduction in student debt.

At least one embodiment of the present invention provides a computerized database access system for generating interest-aligned degree plans. The database access system includes a set of terminals accessible by students for input of search queries and output of search query responses; a database comprising a list of academic majors linked to numeric scores related to personality attributes of students who are likely to be successful in that academic major; and a server, communicating with the set of terminals and the database. The server executes a program stored in memory to (a) receive for a given student a numeric score related to major student personality attributes of the given student; and (b) search through the database to identify at least one major according to a matching between the student personality attributes of the given student and the major personality attributes.

It is thus a feature of at least one embodiment of the invention to assist students in selecting majors/minors according to personality attributes of the student who is undecided about their selected course of study.

The numeric scores may be numbers each associated with different personality characteristics. The numeric score may be a Holland score providing strength values for at least one of the following personality characteristics: Realistic, Investigative, Artistic, Social, Enterprising, and Conventional.

It is thus a feature of at least one embodiment of the invention to utilize recognized personality/interest assessments used to identify major personality characteristics of students and correlate them with characteristics of majors/minors or courses providing an indication of students who excel in particular majors.

The personality attributes may be assigned by student and alumni questionnaires.

It is thus a feature of at least one embodiment of the invention to assign scores to majors/minor and required courses based on descriptions describing the subject matter and format of particular majors/minors or courses. The assignment may also be informed by faculty and student characterizations of the majors/minor or courses.

Matching between the student personality attributes of the given student and the major personality attributes may be based upon calculating a Euclidean distance between the numeric scores.

It is thus a feature of at least one embodiment of the invention to match students with majors/minors and courses that are closely aligned with their personality traits.

The database may further comprise one or more academic minors linked to numeric scores related to personality attributes of students who are likely to be successful in that academic minor, where the server further executes a program stored in memory to search through the database to identify at least one minor according to a matching between the student personality attributes of the given student and the minor personality attributes. The server may further execute a program stored in memory to receive an input from the student denoting at least one preferred major.

It is thus a feature of at least one embodiment of the invention to allow for student input in the evaluation process to account for a student's particular tastes, interests and inclinations.

A database may comprise a list of courses linked to course personality attributes, where the server further executes a program stored in memory to search through the database to identify at least one course that is a requirement for the at least one major. The server may further execute a program stored in memory to generate at least one customized selection of required courses biased toward courses matching closest to the student personality attributes of the given student.

It is thus a feature of at least one embodiment of the invention to assist the student in selecting courses fulfilling the requirements of each major/minor and tailoring the suggested courses to the best “fit” for the student's personality.

The server may further execute a program stored in memory to receive an input from the student of courses already completed by the student; and adjust the customized selection of required courses removing the completed courses.

The server further executes a program stored in memory to calculate a number of semesters needed to complete a degree based upon the customized selection of required courses. The server may further execute a program stored in memory to generate a set of customized selections of required courses taking a least amount of time to complete.

It is thus a feature of at least one embodiment of the invention to provide “shortest” path options for the student increasing student retention and minimizing the amount of student debt because of unnecessary delay in scheduling or unneeded classes.

The server may further execute a program stored in memory to output a report displaying the at least one major or at least one course. The server may further execute a program stored in memory to send the report to a guidance counselor or advisor.

It is thus a feature of at least one embodiment of the invention to allow for counselor, advisor, or parental participation in the major/minor and course selection process.

At least one alternative embodiment of the present invention provides a method of matching courses and degrees to student interests to provide a set of optimized degree plans, comprising the steps of: providing a system comprising a set of terminals accessible by students for the input of search queries and the output of search query responses; a database comprising a list of academic majors linked to numeric scores related to personality attributes of students who are likely to be successful in that academic major; and a server, communicating with the set of terminals and the database, and executing a program stored in memory; receiving for a given student a numeric score related to major student personality attributes of the given student; and searching through the database to identify at least one major according to a matching between the student personality attributes of the given student and the major personality attributes.

These particular objects and advantages may apply to only some embodiments falling within the claims and thus do not define the scope of the invention.

### BRIEF DESCRIPTION OF THE DRAWINGS

FIG. 1 is a simplified block diagram of a computer system for intercommunicating with university databases of courses and majors as well as multiple individuals including students and counselors through associated electronic devices;

FIG. 2 is a data flow diagram showing various databases and processing steps used in the present invention;

FIG. 3 is a software flowchart showing the processing steps used in the flow diagram of FIG. 2 in more detail;

FIG. 4 is an example degree planning report provided to a student prepared using the present invention; and

FIG. 5 is a simplified diagram of a scheduling tool that may optionally be used to schedule courses selected by the present invention.

### DETAILED DESCRIPTION OF THE PREFERRED EMBODIMENT

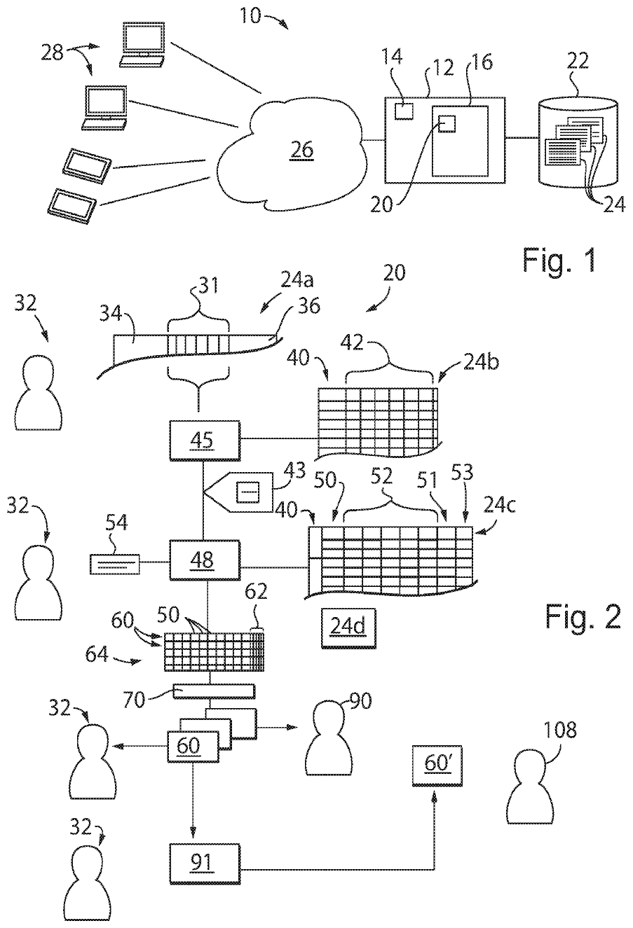

Referring now to FIG. 1, an interest-aligned degree (IAD) planning system 10 may provide for a central server 12, for example, providing one or more processors 14 communicating with processor memory 16 holding a stored program 20 as will be described below. The program 20 may communicate with a database 22 providing data tables 24 including, for example, lists of majors and courses augmented according to the present invention to have Holland vectors (as will be described), rule tables related to academic requirements, and particular degree plans generated by the present invention as will also be discussed below.

The central server 12 may communicate via the web 26 or other network with a variety of remote terminal devices 28, for example, desktop computers and mobile devices such as tablets or smart phones or the like accessible to students and counselors for interaction with the degree planning system 10.

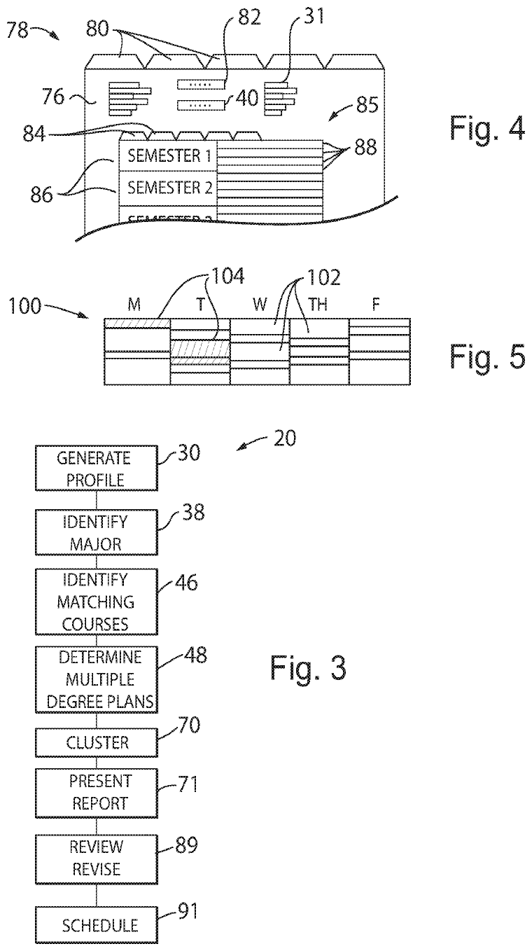

Referring now to FIGS. 2 and 3, the present invention may provide for a student record table 24a having logical rows associated with each student and used for recording degree planning information. As indicated by process block 30 of FIG. 3, a student interest vector 31 may be entered into the student record table 24a, the student interest vector (SIV) 31 characterizing the student's personality/interests. In one embodiment, this student interest vector 31 may be obtained from a Holland personality/interest assessment which yields a six element numeric vector providing values for six attributes Realistic (Doers), Investigative (Thinkers), Artistic (Creators), Social (Helpers), Enterprising (Persuaders), and Conventional (Organizers). Research suggests that these categories can identify career environments in which an individual having particular attributes can flourish.

This student interest vector 31 may be provided by the student 32 by entering numbers associated with each of these attributes, for example those obtained in a separately administered test, through device 28. As well as holding the student interest vector 31, table 24a thus can include student identification information 34 including, for example, the student's name, identification number, a password and authentication data. The table 24a will also hold degree plan information 36 developed by the present invention as will be discussed.

The program 20 executed on the server 12 may then identify one or more matching academic majors and minors 43 matching the Holland vector 31 as indicated by process block 38. For this purpose the program 20 refers to data table 24b providing a list of academic majors 40 (and minors), for example, in a logical column of table 24b together with corresponding Holland vectors 42 linked to each major (and minor).

This data table 24b providing this set of linked majors/minors and Holland vectors 42 may be developed in a number of ways. Initially, educational experts in the various fields may assign Holland vectors 42 to the majors and minors based on inspection using knowledge of the definition of each value of the Holland vector 42 and knowledge of the nature of the academic discipline represented by the major/minor. Alternatively, Holland vectors assigned (for example by inspection) to each course in the major may be combined (for example by averaging or weighted averaging) to produce the Holland vector 42 for the major or minor related to those courses. Student and alumni questionnaires may also be used for the purpose of assigning Holland vectors 42 to the courses and or majors. Assignment of the Holland vector 42 may take into account the subject matter covered by the course and the format of the course. Keywords located in the course descriptions may assist with assignment of the Holland vector 42, for example, courses involving “hands-on learning” may obtain a higher score in Investigative, and courses involving “community based learning” may obtain a higher score in Social. Ideally, the Holland vector assigned to each course reflects personality traits of students who are likely to be successful in that course or the course's major.

The Holland vector 42 for a particular course or major may encompass a score, for example, between 0 and 100, denoting the strength of each of the six attributes. Attributes that are not relevant to a particular course or major may be assigned a 0 while attributes that are relevant are scored based on their perceived strength. For example, a sample Holland vector 42 for a course or major may be: 20 Realistic, 0 Investigative, 0 Artistic, 30 Social, 0 Enterprising, and 50 Conventional.

The process of matching the student's Holland vector 31 with one or more academic majors/minors 43, for example, may calculate a Euclidean distance (or use a different metric) between the student's Holland vector 31 and each of the vectors 42, per process block 45, to provide, for example, the five or six closest majors/minors 40 to the students Holland vector 31 as selected majors/minors 43. These selected majors/minors 43 may be presented to the student 32 together with their associated Holland vectors 42 (for example next to or superimposed on Holland vector 31) to allow the student 32 to choose a subset of the selected majors/minors 43. Alternatively, the student may allow this choosing process to be conducted automatically with the top majors/minors 43 selected according to Euclidean distance (or an alternative metric) from the student's Holland vector 31.

At a next step, indicated by process block 46 of FIG. 3 and process block 48 of FIG. 2, the program 20 reviews a table 24c providing courses 50, for example, in a logical column linked to the selected majors 43 chosen by the student 32. Each course 50 is also linked to a corresponding Holland vector 52 as discussed above. This table 24c may also hold prerequisites 51 for each course 50 as well as course rotation information 53 (when the course 50 is available).

At this point, the student 32 may further enter courses 54 that the student 32 has already completed which will be used in the planning process. The program 20 also uses table 24d containing rules related to academic requirements (distribution requirements, maximum course load, minimum course load, etc.).

The above described tables 24 are then used as indicated by process block 48 to generate a collection of “shortest path” semester-by-semester degree plans corresponding to the selected majors (and minors) and also aligned with the student's Holland vector 31. This process of process block 48 may invoke automatic degree planning steps as follows:

According to the input selections (i.e., majors, minors, degree type (e.g., BA or BS)), the planning process block 48 will set the corresponding requirements for the degree for example from table 24d. The planning process block 48 will then generates a set S of all the courses 50 that appear in the requirements for the matching academic majors 43 and the prerequisites for these courses 50.

The planning process block 48 applies the student's completed courses 54 to the requirements for the major, and generates a subset (S*) of S that completes the major requirements. The selection of courses for this subset may be biased according to their distance from the SIV. Based on recommendation from the major department contained in rules table 24d, a limit (e.g., 2 or 3) is set on the number of courses in the major allowed per semester. This feature is intended to ensure that a student is not overwhelmed by taking too many demanding courses in one semester, but this value can be overridden in consultation with an advisor.

A binary optimization problem is then solved to determine the minimum number of remaining semesters required to complete the major requirements (taking into account pre-requisites and course rotation schedules). This number is then compared with the minimum number of semesters needed to complete the degree credit requirement also contained in the rules table 24d (typically 60 credits for a two-year degree and 120 credits for a four-year degree) and the larger of these two numbers is used to set D, the semesters-to-degree value.

The planning process block 48 then applies the student's completed courses 54 to the remaining set of degree requirements, and generates a set T of all the courses that appear in the requirements and their prerequisites. This set may contain generic “placeholders” for courses in certain sets such as general electives.

The process block 48 generates a subset (T*) of T to complete the remaining degree requirements per rule table 24d while minimizing the total number of credits and giving preference to the courses closest to the SIV. Note that courses relevant to general education requirements as well as elective courses are selected at this step. This step requires the resolution of requirement conflicts (i.e., a course may be required by both a major and minor but it can be applied to one place). The planning process block 48 also selects a unique set of prerequisites 51 for each course derived from table 24c. The minimization is done with a heuristic technique that uses biased randomized sequences of T⁻ to generate feasible T*s.

A dynamic priority scheduling (DPS) engine is used to produce optimized semester plans. This involves the following three steps.
For each future semester i:
(a) Construct the prerequisite-rotation graph (described below) for T*.
(b) Calculate priority weights of the courses in T*.
(c) Solve a knapsack problem (per Martello, S. and Toth, P., Knapsack
Problems: Algorithms and Computer Implementation. John Wiley and Sons, 1990—henceforth Martello and Toth, 1990) associated with the above calculated priority weights to obtain an optimal set of courses (Ti*) and assign them to the current semester i. Remove the courses in Ti* from T* and start with step 5(a) for the semester i+1.

Steps (a) to (c) will be repeated until all courses are assigned to obtain a valid degree plan. If more than D semesters are needed to obtain a valid degree plan, a warning label will be attached to the plan advising the student 32 that the plan does not have the desired number of semesters.

Each iteration performed by the DPS thus corresponds to a semester in the degree plan and selects the courses that will appear in the plan for that semester to produce a semester by semester degree plan 60. The DPS accomplishes this course selection by first constructing at each iteration a prerequisite rotation graph (PRG) and using this graph to calculate priority weights for courses based on longest paths, prerequisite dependencies and course rotation schedules. The engine then constructs and solves via dynamic programming (or any of the alternative knapsack solution methods described in (Martello and Toth, 1990)) a knapsack problem based on these dynamic priority weights as follows:

Let pw1, pw2, . . . , pwt be the priority weights of the courses that may be taken in the semester Si under consideration, and let c1, c2, . . . , ct be their corresponding credit hours. Let Ui be the maximum credit limit for the semester Si. We assign courses to the ith semester by using dynamic programming to solve the following knapsack problem, where the binary variables x[j] have value 1 if course j is taken in the semester and 0 otherwise:

Maximize z=Σⱼ₌₁^{t}pwⱼ*cⱼ*x[j] subject to:

Semester credit limits: Σⱼ₌₁^{t}cⱼ*x[j]≤Uᵢ

To the above optimization problem may be added other constraints or objective function terms based on student preferences such as limits on number of general education courses may be applied from table 24d.

For each degree plan 60 thus constructed, a Holland vector 62 is computed dynamically based on the Holland vector 52 of the courses 50 as they are added to the plan 60. This degree planning process is repeated for the various major/minor/degree options selected by the student 32 (or system). Internal selection parameters (such as preferred departments for general education requirements) are also varied so that a large number (e.g., 100) of degree plans are generated. The speed of the degree planning process allows this to be done in a fraction of a second.

Note that a straightforward approach to this problem will generally not be satisfactory in terms of the computing time required because of the size and complexity of the overall problem, which, in the case of degree planning, involves many eligible courses per semester and many semesters, and thus can involve a problem with more than a thousand variables and constraints. Combinatorial optimization problems related to sequencing and scheduling can be difficult to solve. The current approach utilizes a pre-processing step involving only the major requirements to set a lower bound on time to degree, followed by a semester-by-semester approach with a sequence of small carefully-constructed subproblems to quickly achieve shortest path degree plans.

Using this process, a collection of degree plans 64 is generated. In order to make this large number of plans 60 in the collection of degree plans 64 manageable, at process block 70, the plans 60 of the collection of degree plans 64 are separated into clusters using clustering techniques such as that described in “Cluster Analysis, Fifth Edition”, Brian S. Everitt, Sabine Landau, Morven Leese, Daniel Stahl, ISBN: 9780470749913, for example, 10 clusters each with 10 plans 60. Generally the clusters are defined in six dimensions of the Holland vectors 62 to group plans 60 whose Holland vectors 62 are closest.

For each cluster a cluster center is computed as the average of the Holland vectors of the cluster members, and this center is translated into an ordered set of six RIASEC letters termed the cluster label 76 to facilitate understanding by the student 32. Note that some clusters may have the same RIASEC label so the label in such cases could be augmented by a numerical suffix 1, 2, . . . .

Referring now to FIG. 4, the student 32 may be presented with a report 78 as indicated by process block 71 (shown in FIG. 3), for example, providing a multi-tabbed form where each tab 80 represents a different cluster. Clicking on one tab 80 will bring up information about the particular cluster including the cluster label 76 as well as the student's Holland vectors 31 so that the two can be compared. A closeness value 82 may be provided indicating how close the cluster label 76 is to the Holland vectors 31 and, in fact, the tabs 80 may be ranked according to closeness. Information about the associated major 40 may also be applied.

This report 78 may provide a set of secondary tabs 84 that may be used to select and review particular plans 60 within the cluster. Clicking on each tab presents a table 85 divided into semesters 86 and listing for each semester the selected courses 88 necessary for that plan 60. In this way the student 32 may quickly review a set of feasible degree plans.

The student 32 may be provided with comparison tools to compare plans 60 from various clusters, for example, on a side-by-side basis.

Once the student 32 has found one or more degree plans that are appealing, these plans may be saved electronically. Saved plans can then be electronically forwarded and discussed with advisors, family, or peers, and commitments to carrying out plans can be developed.

Referring now to FIGS. 2 and 3, as indicated by process block 89, annotations regarding the report 78 or individual plan 60 selected by the student 32 may then be saved in the degree plan information 36 and routed by the student 32, for example, to a guidance counselor 90 or to advisors families or peers for discussion with the student. Annotations can also be routed from a guidance counselor or advisor to a student. At this time the advisor 90 may recommend changes or substitutions of particular courses or other modifications to the rules provided by the rule tables 24d.

Referring now to FIGS. 3 and 5, the invention may further provide a scheduling module indicated by process block 91 presenting the student 32 with a calendar-type display 100, for example, showing in, for example, greyed-out form, all possible schedule times 102 of the classes for a given semester for a given plan 60. Students may then select particular schedule times 104 to build an actual schedule of classes that do not conflict in time with the greyed-out times becoming full color or otherwise indicating selection.

Referring now to FIG. 2, once a plan 60′ is selected by the student 32, this plan 60′ may be used to enroll the student 32 in the necessary classes and importantly may be rerouted to an administrator 108 together with the entire set of selected degree plans 60′ from all of the students to assist the University in planning allocation of resources necessary to meet the desires of their enrolled students.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a computer” and “a processor” or “the microprocessor” and “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It will be appreciated that the student devices 28 represent logical nodes and that they are not necessarily located at a particular location but may follow the designated individuals through a variety of devices.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

What we claim is:

1. A computerized database access system for generating interest-aligned degree plans, the database access system comprising:
a set of terminals accessible by students and configured for input of search queries and output of search query responses;
a database comprising a list of academic majors linked to numeric scores related to personality attributes of students who are likely to be successful in each academic major and indicating a major personality attribute of each academic major;
a server communicating with the set of terminals and the database, and executing a program stored in memory to:
(a) receive for a given student a numeric score related to student personality attributes of the given student; and
(b) search through the database to identify at least one major according to a matching between the student personality attributes of the given student and the major personality attribute of the at least one major.

2. The system of claim 1, wherein the numeric scores are numbers each associated with different personality characteristics.

3. The system of claim 2, wherein the numeric scores are Holland scores providing strength values for at least one of the following personality attributes: Realistic, Investigative, Artistic, Social, Enterprising, and Conventional.

4. The system of claim 2, wherein the major personality attributes of each academic major are determined by previously obtained student and alumni questionnaires.

5. The system of claim 2, wherein matching between the student personality attributes of the given student and the major personality attributes of the at least one academic major is based upon calculating a Euclidean distance between the numeric scores.

6. The system of claim 1, wherein the database further comprises one or more academic minors linked to numeric scores related to personality attributes of students who are likely to be successful in each academic minor and indicating a minor personality attribute of each academic minor, wherein the server further executes a program stored in memory to:
search through the database to identify at least one minor according to a matching between the student personality attributes of the given student and the minor personality attribute of the at least one minor.

7. The system of claim 1, wherein the server further executes a program stored in memory to:
receive an input from the student indicating at least one preferred major of the at least one matching majors.

8. The system of claim 1, further comprising a database comprising a list of courses linked to course personality attributes, wherein the server further executes a program stored in memory to:
search through the database to identify at least one course that is a requirement for the at least one matching majors.

9. The system of claim 8, wherein the server further executes a program stored in memory to:
generate at least one customized selection of required courses biased toward courses matching closest to the student personality attributes of the given student.

10. The system of claim 9, wherein the server further executes a program stored in memory to:
receive an input from the student of courses already completed by the student; and
adjust the customized selection of required courses to remove the completed courses.

11. The system of claim 10, wherein the server further executes a program stored in memory to:
calculate a number of semesters needed to complete a degree based upon the customized selection of required courses.

12. The system of claim 11, wherein the server further executes a program stored in memory to:
generate a set of customized selections of required courses taking a least amount of time to complete.

13. The system of claim 8, wherein the server further executes a program stored in memory to:
output a report displaying at least one of the matching majors or matching courses.

14. The system of claim 13, wherein the server further executes a program stored in memory to:
send the report to a guidance counselor or advisor.

15. A method of matching courses and degrees to student interests to provide a set of optimized degree plans, comprising the steps of:
providing a system comprising a set of terminals accessible by students for input of search queries and output of search query responses, a database comprising a list of academic majors linked to numeric scores related to personality attributes of students who are likely to be successful in each academic major and indicating a major personality attribute of each academic major, and a server communicating with the set of terminals and the database, and executing a program stored in memory;
receiving for a given student a numeric score related to student personality attributes of the given student; and
searching through the database to identify at least one major according to a matching between the student personality attributes of the given student and the major personality attribute of the at least one major.
